(19) United States
(12) Patent Application Publication
(10) Pub. No.: US 2010/0268462 A1
(43) Pub. Date: Oct. 21, 2010

(54) METHOD, SYSTEM AND APPARATUS FOR LOCATION-BASED NAVIGATION

(75) Inventors: Nicholas John Tebbit, Old Windsor Berkshire (GB); Simon James Walke, Beggarwood Basingstoke Hampshire (GB)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/425,274

(22) Filed: Apr. 16, 2009

(51) Int. Cl. G01C 21/30; G01S 3/02

(52) U.S. Cl. 701/211; 342/463; 342/451

(57) ABSTRACT

Methodologies for alerting a user to his or her location using terrestrial wireless signals are included. The methodologies include a method for alerting a user to his or her position relative to a predetermined location in response to a unique identifying signal from a terrestrial base station as well as a navigation method based upon one or more uniquely identifying signals from one or more terrestrial base stations positioned along a desired route. Also disclosed is a mobile terminal, for example, a mobile telephone, that is adapted to alert a user as to his or her location and aid in navigating the user through a selected route in response to the position of the mobile terminal relative to one or more terrestrial base stations.

### BACKGROUND

1. Field

The presently claimed invention relates generally to the field of wireless communications, and more specifically to the field of navigation using terrestrial wireless signals receivable at a mobile terminal.

2. Background

Recent trends in lifestyles relating to work and communications as well as the ever increasing size of metropolitan areas have yielded a very large increase in the number of commuters traveling by rail, bus, carpool and other forms of single and/or mass transportation. Some travelers or commuters may use personal navigation devices for wayfinding and/or navigation. A typical personal navigation device determines its position by triangulating one or more signals from positioning satellites having fixed orbits. Example satellite positioning systems include the GPS constellation, the Galileo constellation and the GLONASS constellation.

While satellite based navigation systems can be highly accurate, they also have their drawbacks that make their performance unavailable to most users. First, handheld positioning systems are typically much more expensive than other handheld devices, such as mobile telephones. Also, given the complexity of the satellite positioning software and firmware, handheld positioning systems are not easily packaged, meaning that each device is bulky and fairly limited in its functionality other than positioning. Lastly, as noted above handheld positioning systems rely on precise receipt and measurement of positioning signals from one or more orbital satellites. As such, weather conditions and line-of-sight issues may hamper the performance of the typical handheld positioning device because it does not receive the proper signals from the satellite(s). By way of comparison, a good portion of the world's population has adopted the mobile telephone as a preferred way of communication. However, most mobile telephones do not have satellite positioning capability due to the aforementioned limitations. Nevertheless, there exists a need in the art for a system, method and/or apparatus that combines the functionality of a handheld positioning device and a mobile telephone while keeping the cost and complexity thereof relatively low.

### SUMMARY

Accordingly, the present disclosure includes a detailed description of multiple example aspects, features and advantages of the presently claimed invention. In one aspect, the presently claimed invention includes a method for alerting a user to the user's presence in a selected location, for example, a commuter train station. As described below, the example method can include the step of receiving, at a mobile terminal, a selection of a predetermined location. The example method can also include the step of receiving, at the mobile terminal, a signal from a base station having a unique location identifier, which functions to uniquely associate a geographical location with the base station, which in turn uniquely identifies the predetermined location with a specified signal. Another step can include alerting a user as to a second, subsequent receipt or re-receipt of the signal from the base station having the unique location identifier. That is, the user's mobile terminal will alert him or her if and when he or she is at or near the predetermined location in response to the unique location identifier from the associated base station. In doing so, the mobile terminal functions in part as a personal navigation device by prompting a user as to his or her location.

Another aspect of the presently claimed invention includes a method of user navigation using a mobile terminal. The example method includes the step of initiating, at a mobile terminal, a navigation request including a first predetermined location and a second predetermined location. As described in detail below, the mobile terminal can be configured for storing previously predetermined locations and associating those locations with the uniquely identified base station. As such, the mobile terminal can have a history of locations from which a user may choose an origination and a destination. The example method can further include the steps of receiving, at the mobile terminal, a first signal from a first base station having a first unique location identifier associated with the first predetermined location; and receiving, at the mobile terminal, a second signal from a second base station having a second unique location identifier associated with the second predetermined location. The example method can further include the step of alerting a user as to the presence of the mobile terminal in one of the first or second predetermined locations in response to receipt, at the mobile terminal, of one of the first or second unique location identifiers.

In addition to the example methods described herein, the present application discloses apparatuses, systems and computer-readable media adapted to perform these and other methodologies for assisting a user in location determination and navigation. It will be apparent to those of skill in the art that the example methodologies, systems and apparatuses disclosed herein are readily scalable for use in a multitude of applications, including at least wayfinding, commuting, traveling and navigation. Unlike the satellite based positioning devices, the teachings of the present application are applicable to the more cost effective and functional mobile terminals such as mobile telephones. Other features and advantages are described in detail below with reference to the following figures.

### BRIEF DESCRIPTION OF THE DRAWINGS

FIG. 1 is a schematic diagram of an operating environment of a mobile terminal in accordance with one aspect of the presently claimed invention.

FIG. 2 is a schematic diagram of a mobile terminal according to one aspect of the presently claimed invention.

FIG. 3 is a schematic diagram of a user interface of a mobile terminal according to another aspect of the presently claimed invention.

FIG. 4 is a flow chart depicting a method of alerting a user to a location in accordance with one aspect of the presently claimed invention.

FIG. 5 is a flow chart depicting a method for personal navigation in accordance with another aspect of the presently claimed invention.

### DETAILED DESCRIPTION

The presently claimed invention is described herein with reference to selected preferred features and aspects thereof with reference to the appended figures. It should be understood by those of skill in the art of communications that the foregoing descriptions are exemplary in nature only, and that the scope of the presently claimed invention is defined by the following claims.

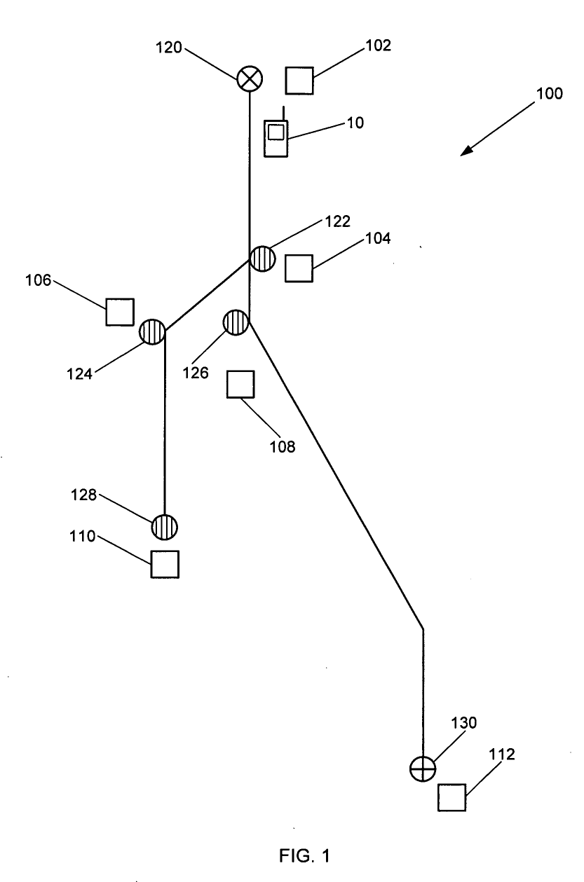

FIG. 1 schematically illustrates a suitable operating environment 100 for various aspects of the systems, apparatuses and methods of the presently claimed invention, all of which described in greater detail herein. The example operating environment 100 includes a plurality of base stations 102, 104, 106, 108, 110, and 112, each of which can be in communication with one or more mobile terminals 10 in a wireless communication network. As used herein, a mobile terminal 10 refers to a device such as a cellular or other wireless communication device, personal communication system (PCS) device, personal navigation device, Personal Information Manager (PIM), Personal Digital Assistant (PDA), laptop or other suitable mobile device that is capable of receiving wireless communications. Also, “mobile terminal” is intended to include all devices, including wireless communication devices, computers, laptops, etc., which are capable of communication with a server, such as via the Internet, WiFi, or other network, and regardless of whether signal reception, data processing and storage, and/or other functions occur at the device, at a server, or at another device associated with the network. Any operable combination of the above are also considered a mobile terminal for purposes of the present application.

The operating environment 100 can also include one or more communications and/or positioning satellites (not shown), as well as a public switched telephone network (PSTN) (not shown). In a typical wireless communications system, the base stations 102, 104, 106, 108, 110, and 112 function to receive communications from mobile terminals 10 on a forward link and transmit communications to mobile terminals 10 on a reverse link. Each base station 102, 104, 106, 108, 110, and 112 typically operates within a cell, or portion of the wireless network, and communications are maintained as a mobile terminal 10 moves from cell to cell through a hand-off between base stations 102, 104, 106, 108, 110, and 112. Each base station 102, 104, 106, 108, 110, and 112 is uniquely identifiable, and thus the general pathway of a mobile terminal 10 can be derived from observing a sequence of hand-offs between base stations 102, 104, 106, 108, 110, and 112. As used herein, the term base station refers to a terrestrial wireless communications gateway through which wireless communications are routed between mobile terminals. Although a typical base station may be adapted for satellite and terrestrial wireless communications, each base station can be uniquely identified by a terrestrial signal transmitted to one or more mobile terminals.

As shown in FIG. 1, the plurality of base stations 102, 104, 106, 108, 110, and 112 can be arranged at or near a series of predetermined locations 120, 122, 124, 126, 128, and 130, such that each of the series of predetermined locations 120, 122, 124, 126, 128, and 130 can be associated with the uniquely identifying signal(s) for the geographically corresponding base station 102, 104, 106, 108, 110, and 112. In this example, the lines linking the locations are train tracks. As shown, predetermined location 120 is within the cell or region of base station 102, predetermined location 122 is within the cell or region of base station 104 and so on and so forth. In the example operating environment 100, each of the predetermined locations 120, 122, 124, 126, 128, and 130 can have a separate geographical significance, such as stops on a commuter train line, intersections on a network of roads traveled by bus or other vehicle, junctions, transfer stations, residences, workplaces, trip origins, trip destinations and the like.

Techniques described herein may be used for various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a Long Term Evolution (LTE) network, and so on. A CDMA network may implement one or more radio access technologies (RATs) such as CDMA2000, Wideband-CDMA (W-CDMA), and so on. CDMA2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). CDMA2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be used for any combination of WWAN, WLAN and/or WPAN.

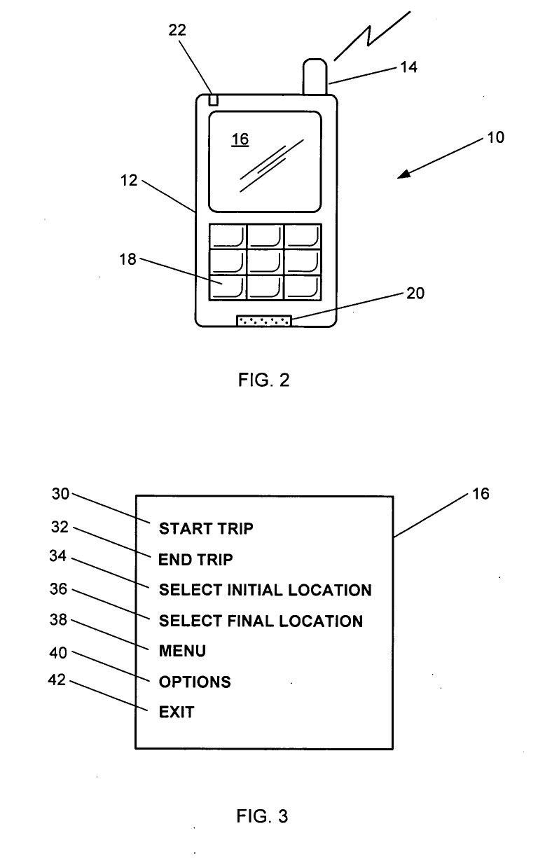

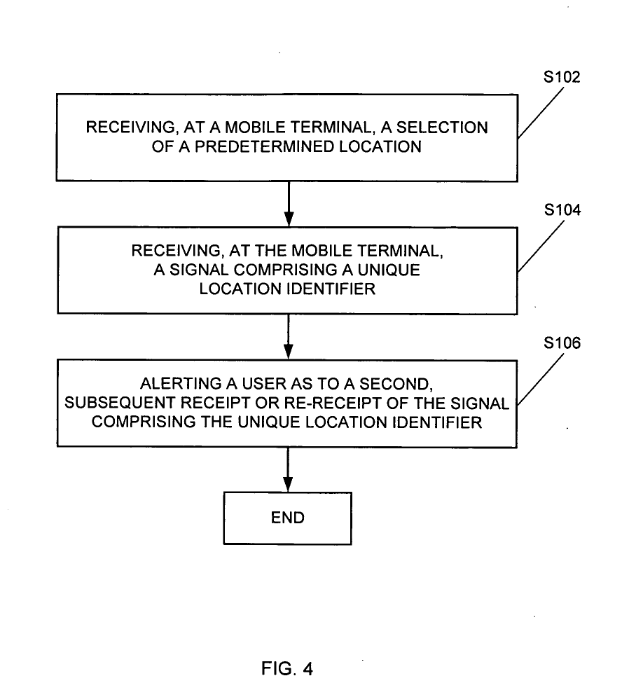

One aspect of the presently claimed invention includes a method for alerting a user to the user's presence in a selected location, for example a commuter train station. As shown in FIG. 4, the example method can include step S102, which includes receiving, at a mobile terminal, a selection of a predetermined location. Step S104 of the example method includes receiving, at the mobile terminal, a signal from a base station comprising a unique location identifier. Such a signal may include location area identifier (LAI)/cell identity/base station identity code for GSM, or base station identification/base station longitude/base station latitude for CDMA, and may uniquely associate a geographical location with the base station. The mobile terminal can store the signal strength of the signal from the base station. Step S104 can function to uniquely associate a geographical location with the base station, which in turn uniquely identifies the predetermined location with a specified signal. For example, upon receiving the signal at the predetermined location (e.g., a user's home train station), a processing unit of mobile terminal 10 of FIG. 2 can process the signal and associate location area identifier (LAI)/cell identity/base station identity code of the base station transmitting the signal with the predetermined location. This association can be stored in a data structure and used to identify a second, subsequent signal from the base station and can occur in response to user input. Step S106 includes alerting a user as to a second, subsequent receipt or re-receipt of a signal from the base station comprising the unique location identifier. For example, the mobile terminal can alert the user when the strength of the signal from the base station reaches the stored signal strength described previously. As an example, the user may select a train station near his or her place of work as the predetermined location. Upon completion of steps S102 and S104 of the example method, the user's mobile terminal will alert him or her if and when he or she is at or near the place of work in response to the unique location identifier from the associated base station. In doing so, an otherwise tired or distracted user will be less likely to miss his or her stop, transfer station, turn or other navigable event.

In one variation of the example method shown in FIG. 4, the selection of a predetermined location occurs in response to a user input. The user input can include manual input of the predetermined location into the mobile terminal, or user input through some other method such as voice activation, download from an ancillary personal computer, personal positioning device or navigation system. Alternatively, the selection of the predetermined location can include the initiation of a trip function performed on the mobile terminal. A suitable trip function can include an origin point and a destination point such that the predetermined location comprises one of an origin or a destination. That is, a user can select a common trip having a consistent origin point (i.e., home train station) and destination (i.e., office train station) such that the example method functions to alert the user as to his or her physical presence at or near the base station associated with the origin and/or destination. Each origin and destination can be associated with distinct base stations, each of which is uniquely identifiable through its signaling.

In another alternative aspect of the example method, the selection of the predetermined location can be established in accordance with a predetermined route or pathway selected by the user, wherein the predetermined location is geographically or otherwise associated with the selected route, which can include for example waypoints in addition to an origin and a destination, such as train transfer stations, bus stops, driving intersections and the like.

In another variation of the example method, the step of alerting the user can include various alarm means and mechanisms. For example, the example method can alert the user by causing the mobile terminal to perform an auditory alarm through a speaker or headphone, causing the mobile terminal to perform a visual alarm through a blinking light, flashing screen or other visible indicator, or causing the mobile terminal to perform a tactile alarm such as vibrating. To that end, the mobile terminal 10 can be configured for one or more of the preceding functions, having one or more of a speaker, headphone jack, LED or other flashable light, display or screen and a vibration or silent alarm mechanism.

As shown in FIGS. 2 and 3, an example mobile terminal 10 can include a body portion 12 containing a processing unit, memory, communications circuitry, hardware, firmware and software all adapted for mobile wireless communications. The example mobile terminal 10 can also include a user interface adapted to permit the user to select a predetermined location. As shown in FIG. 2, the user interface can include for example tactile-input interface that has a display 16 and a keypad 18. Alternatively, the user interface can include only a display 16, provided that the display 16 is a touch-screen interactive display of the type becoming more common in the mobile terminal 10 industry. In another alternative, the user interface can be voice activated through a microphone/speaker 20 as shown in FIG. 2. The mobile terminal 10 can also include an antenna 14 adapted to receive a wireless signal from a base station, which includes the unique location identifier noted herein. The user interface and the antenna 14 can be connected to a processing unit (not shown) that is configured to associate the unique location identifier in the wireless signal from the base station with the predetermined location and alert a user in response to the receipt of a second wireless signal from the base station comprising the unique location identifier. The processing unit can determine the signal strength of a signal from the base station, store the signal strength, and compare the signal strength of a received signal with the stored signal strength.

The example mobile terminal 10 can further include an alert system (not shown) connected to the processing unit. The alert system can function to alert a user as to his or her presence at or near a predetermined location through a vibration alarm, an audio alarm or a visual alarm. As shown in FIG. 2, the example mobile terminal 10 can include a display 16, which can function as a visual alarm. Moreover, the example mobile terminal 10 can utilize an LED or battery light 22 as a visual alarm. Likewise, the microphone/speaker 20 of the example mobile terminal 10 can function as an audio alarm for alerting the user. Additionally, the example mobile terminal 10 can include a vibrating mechanism, motor or device (not shown) as a vibration or silent alarm. One or more of the aforementioned alert system components can be used for each alert event, or alternatively, a specific type of alert can be configured for each of the predetermined locations selected by the user. For example, the processing unit can control the microphone/speaker to speak or say specific words or phrases, such as “home”, “work”, “transfer”, “turn left” and the like when a user is at or near the associated predetermined location.

Additional functionality of the example mobile terminal 10 is shown in FIG. 3, which illustrates an example display 16 portion of a user interface of the type described above. In aiding a user in selecting a predetermined location, beginning a trip, or navigating a route, the processing unit of the mobile terminal 10 can cause the display 16 to present a menu of options for a user. Example options presented to a user can include for example a start trip function 30 and an end trip function 32. Upon initialization of a start trip function 30, the mobile terminal 10 can identify the trip's starting location as a first predetermined location in accordance with the methodologies described herein. Similarly, at the end trip function 32 the mobile terminal 10 can identify the trip's ending location as a second predetermined location in accordance with the methodologies described herein. For a trip that is repeated, this functionality will allow a user to have the start and end points of a daily commute for example pre-selected by the mobile terminal 10, which in turn will notify the user of his or her location in accordance with the methodologies described herein.

Another example option is a select initial location function 34 and a select final location function 36, which permit the user to create alerts based upon his or her past, current or future location(s). Additional options include a menu function 38, an options function 40 for adjusting the functionality of the mobile terminal 10, i.e., the type of alert system used by the mobile terminal 10 and an exit function 42 to return to another functionality of the mobile terminal 10. The mobile terminal 10 can also include software, hardware and firmware for generating a visual map of a user's vicinity based upon the known location of the mobile terminal 10 derived from the uniquely identified base stations.

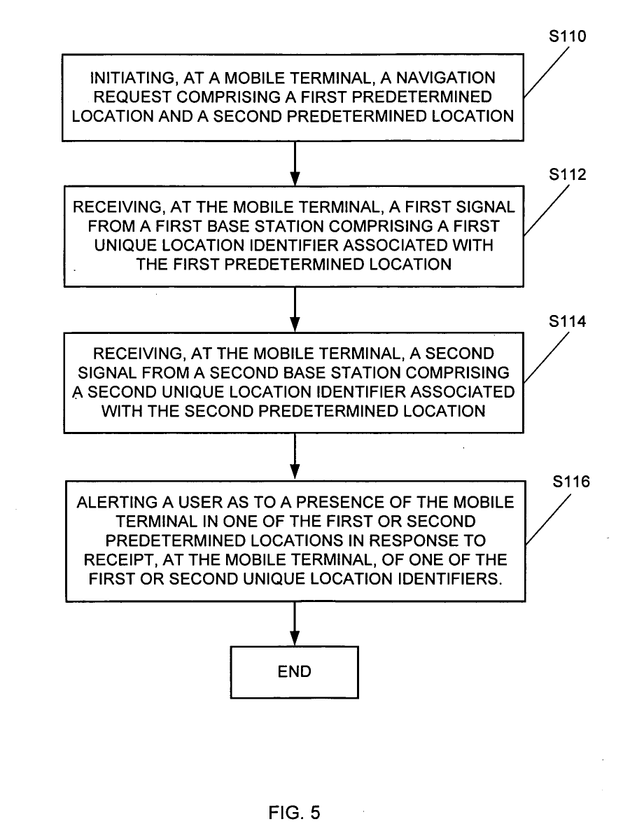

In that regard, another aspect of the presently claimed invention includes a method of user navigation using a mobile terminal. As shown in FIG. 5, the example method includes step S110, which includes initiating, at a mobile terminal, a navigation request comprising a first predetermined location and a second predetermined location. As noted above, the mobile terminal can be configured for storing previously predetermined locations and associating those locations with a uniquely identified base station. As such, the mobile terminal can have a history of locations from which a user may choose an origination and a destination. In step S112, the example method includes receiving, at the mobile terminal, a first signal from a first base station comprising a first unique location identifier associated with the first predetermined location; and in step S114 the example method includes receiving, at the mobile terminal, a second signal from a second base station comprising a second unique location identifier associated with the second predetermined location. In step S116, the example method includes alerting a user as to the presence of the mobile terminal in one of the first or second predetermined locations in response to receipt, at the mobile terminal, of one of the first or second unique location identifiers.

Referring again to FIG. 1 as an example operating environment, a user may desire to get from predetermined location 120 to predetermined location 130. In doing so, the user will pass through predetermined location 122 and predetermined location 124, which may be commuter rail junctions, stops and the like. In order to alert the user to an impending waypoint, such as predetermined location 122, the example method can further include the step of receiving, at the mobile terminal, a third signal from a third base station comprising a third unique location identifier associated with a third predetermined location. In this manner, the user is alerted as to the presence of the predetermined location 122, for example a commuter rail junction, and will follow the appropriate steps to ensure that he or she gets on the proper train to reach his or her destination, predetermined location 130.

As noted above, the third predetermined location can be any number of waypoints, intersections, junctions, intermediate points of interest, stops and so forth along a route between the first and second predetermined locations. The example method permits a user to successfully navigate a complicated route by bus, rail, car, by foot or other means by alerting the user to his or her presence at or near a predetermined waypoint along the route. It should be apparent to those of skill in the art that the methodologies described herein are not only suited for first, second and third predetermined locations, but for any number of geographical areas capable of being uniquely identified by a base station signal. As those of skill in the art will appreciate, the density of base stations in a region is roughly proportional to the population density of that region, and thus in densely populated areas the principles described herein will provide positioning and navigation performance comparable to that found in the more expensive and complex satellite-based positioning systems.

The methodologies described herein may be implemented by various means depending upon the application. For example, these methodologies may be implemented in hardware, firmware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory, for example the memory of a mobile terminal 10, and executed by a processing unit, as described above with reference to the mobile terminal 10. Memory may be implemented within the processing unit or external to the processing unit. As used herein the term “memory” refers to any type of long term, short term, volatile, nonvolatile, or other memory and is not to be limited to any particular type of memory or number of memories, or type of media upon which memory is stored. Unless specifically stated otherwise, as apparent from the preceding discussion, it is appreciated that throughout this specification methodologies relating to flow diagrams or otherwise, may also be executed and/or controlled, in whole or in part, by a computing platform including for example the mobile terminal and/or base station(s) described in detail above.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processing units to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

The preceding descriptions are related to selected aspects and preferred examples of the systems and methods of the presently claimed invention. It should be understood by those of skill in the art that these descriptions are exemplary in nature, and that the full scope and import of the presently claimed invention is defined with reference to the following claims.

What is claimed is:

1. A method for alerting a user to the user's presence in a selected location comprising the steps of:
receiving, at a mobile terminal, a selection of a predetermined location;
receiving, at the mobile terminal, a signal from a base station comprising a unique location identifier; and
alerting a user as to a subsequent receipt of the signal from the base station comprising the unique location identifier.

2. The method of claim 1, wherein the selection of a predetermined location occurs in response to a user input.

3. The method of claim 1, wherein the selection of a predetermined location comprises a trip function comprising an origin point and a destination point, and further wherein the predetermined location comprises one of an origin or a destination.

4. The method of claim 3, wherein the origin is associated with one of the base station and a second base station and the destination is associated with an opposite of the one of the base station and the second base station.

5. The method of claim 1, wherein the step of alerting the user comprises one of causing the mobile terminal to perform an auditory alarm, causing the mobile terminal to perform a visual alarm, or causing the mobile terminal to perform a tactile alarm.

6. An apparatus for alerting a user to the user's presence in a selected location comprising:
means for receiving, at a mobile terminal, a selection of a predetermined location;
means for receiving, at the mobile terminal, a signal from a base station comprising a unique location identifier; and
means for alerting a user as to a subsequent receipt of the signal from the base station comprising the unique location identifier.

7. The apparatus of claim 6, wherein the selection of a predetermined location occurs in response to a user input.

8. The apparatus of claim 6, wherein the selection of a predetermined location comprises a trip function comprising an origin point and a destination point, and further wherein the predetermined location comprises one of an origin or a destination.

9. The apparatus of claim 8, wherein the origin is associated with one of the base station and a second base station and the destination is associated with an opposite of the one of the base station and the second base station.

10. The apparatus of claim 6, wherein the means for alerting the user comprises one of an auditory alarm, a visual alarm or a tactile alarm.

11. A mobile terminal for alerting a user to the user's presence in a selected location comprising:
a user interface adapted to permit the user to select a predetermined location;
an antenna adapted to receive a wireless signal from a base station, the wireless signal from the base station comprising a unique location identifier; and
a processing unit connected to the user interface and the antenna and configured to associate the unique location identifier in the wireless signal from the base station with the predetermined location and alert a user in response to a subsequent receipt of the wireless signal from the base station comprising the unique location identifier.

12. The mobile terminal of claim 11, wherein the user interface comprises one of a tactile-input interface or a voice-activated interface.

13. The mobile terminal of claim 11, further comprising an alert system connected to the processing unit, the alert system adapted to alert a user through a vibration alarm, an audio alarm or a visual alarm.

14. A computer-readable medium encoded with instructions which are hardware computer-executable to implement an alert to a user to the user's presence in a selected location, the instructions comprising:
code to cause a processing unit to receive a selection of a predetermined location;
code to cause the processing unit to receive a wireless signal from a base station, the wireless signal from the base station comprising a unique location identifier; and
code to cause the processing unit to associate the unique location identifier in the wireless signal from the base station with the predetermined location and alert a user in response to a subsequent receipt of the wireless signal from the base station comprising the unique location identifier.

15. The computer-readable medium of claim 14, further comprising code to cause the processing unit to select the predetermined location in response to a user input.

16. The computer-readable medium of claim 14, wherein the code to cause the processing unit to receive a selection of a predetermined location comprises a trip function comprising an origin point and a destination point, and further wherein the predetermined location comprises one of an origin or a destination.

17. The computer-readable medium of claim 16, wherein the origin is associated with one of the base station and a second base station and the destination is associated with an opposite of the one of the base station and the second base station.

18. The computer-readable medium of claim 14, further comprising code to cause the processing unit to operate an auditory alarm, a visual alarm, or a tactile alarm.

19. A method of user navigation using a mobile terminal, the method comprising the steps of:
initiating, at a mobile terminal, a navigation request comprising a first predetermined location and a second predetermined location;
receiving, at the mobile terminal, a first signal from a first base station comprising a first unique location identifier associated with the first predetermined location;
receiving, at the mobile terminal, a second signal from a second base station comprising a second unique location identifier associated with the second predetermined location; and
alerting a user as to the presence of the mobile terminal in one of the first or second predetermined locations in response to receipt, at the mobile terminal, of one of the first or second unique location identifiers.

20. The method of claim 19, further comprising the step of receiving, at the mobile terminal, a third signal from a third base station comprising a third unique location identifier associated with a third predetermined location.

21. The method of claim 20, wherein the third predetermined location is along a route selected by the user.

22. The method of claim 21, wherein the third predetermined location is disposed between the first predetermined location and the second predetermined location.

23. The method of claim 22, further comprising the step of alerting a user as to the presence of the mobile terminal in the third predetermined location in response to receipt, at the mobile terminal, of the third unique location identifier.
